(19) United States
(12) Patent Application Publication
(10) Pub. No.: US 2024/0360028 A1
(43) Pub. Date: Oct. 31, 2024

(54) CRYSTALLIZED GLASS, GLASS SUBSTRATE FOR HIGH FREQUENCY DEVICE, LIQUID CRYSTAL ANTENNA, AMORPHOUS GLASS AND METHOD FOR PRODUCING CRYSTALLIZED GLASS

(71) Applicant: AGC Inc., Tokyo (JP)

(72) Inventors: Kazuki KANEHARA, Tokyo (JP); Yutaka KUROIWA, Tokyo (JP)

(73) Assignee: AGC Inc., Tokyo (JP)

(21) Appl. No.: 18/769,571

(22) Filed: Jul. 11, 2024

Related U.S. Application Data
(63) Continuation of application No. PCT/JP2023/000235, filed on Jan. 6, 2023.

(30) Foreign Application Priority Data
Jan. 14, 2022 (JP) 2022-004642

(51) Int. Cl. C03C 10/00; C03C 3/062; C03C 3/093; C03C 3/097; C03C 4/00

(52) U.S. Cl. CPC C03C 10/0036; C03C 3/062; C03C 3/093; C03C 3/097; C03C 4/00; C03C 2204/00

(57) ABSTRACT

The present invention relates a crystallized glass having a composition that includes, in terms of molar percentage based on oxides: 40% to 70% of SiO₂; 7.5% to 30% of Al₂O₃; 0.5% to 15% of P₂O₅; 13% to 30% of a total content of one or more selected from SrO and BaO; and 2.5% to 10% of a total content of one or more selected from TiO₂ and ZrO₂, and including at least one crystal of a celsian crystal and a hexa-celsian crystal.

### CROSS-REFERENCE TO RELATED APPLICATIONS

This is a continuation of International Application No. PCT/JP2023/000235 filed on Jan. 6, 2023, and claims priority from Japanese Patent Application No. 2022-004642 filed on Jan. 14, 2022, the entire contents of which are incorporated herein by reference.

### TECHNICAL FIELD

The present invention relates to a crystallized glass, a glass substrate for a high frequency device, a liquid crystal antenna, an amorphous glass, and a crystallized glass production method.

### BACKGROUND ART

In recent years, wireless transmission using a microwave band or a millimeter wave band has attracted attention as a large-capacity transmission technique. As a signal frequency increases with expansion of a frequency to be used, a dielectric substrate having excellent dielectric properties in a high frequency is required.

Examples of a material of the dielectric substrate include quartz, ceramics, and a glass. Here, among the glass, a crystallized glass in which a part of the glass is crystallized can be easily molded and inexpensively produced as compared with quartz or ceramics, and has an advantage that the dielectric properties can be further improved. Therefore, there is a need for development of a crystallized glass suitable for a glass substrate for a high frequency device.

Examples of the crystallized glass having excellent dielectric properties include a crystallized glass including an indialite crystal or cordierite crystal, as disclosed in Patent Literature 1. However, since the crystallized glass has a relatively smaller thermal expansion coefficient than the indialite crystal or cordierite crystal, when, for example, used as a dielectric substrate by adhering to other members such as a Si substrate or a Cu electrode, a difference in thermal expansion coefficient becomes large and there is a risk that the members may peel off from each other.

Examples of a crystallized glass exhibiting a thermal expansion coefficient suitable for the above application include a crystallized glass including a celsian crystal as disclosed in Patent Literature 2, for example. However, dielectric properties of the crystallized glass have not been studied so far.

### CITATION LIST

### Patent Literature

Patent Literature 1: WO 2020/023205
Patent Literature 2: WO 2009/029263

### SUMMARY OF INVENTION

### Technical Problem

Therefore, an object of the present invention is to provide a crystallized glass having excellent dielectric properties and thermal expansion coefficient as a glass substrate for use in a high frequency device.

### Solution to Problem

The crystallized glass according to an embodiment of the present invention having a composition that includes, in terms of molar percentage based on oxides:
40% to 70% of SiO₂;
7.5% to 30% of Al₂O₃;
0.5% to 15% of P₂O₅;
13% to 30% of a total content of one or more selected from SrO and BaO; and
2.5% to 10% of a total content of one or more selected from TiO₂ and ZrO₂, and including at least one crystal of a celsian crystal and a hexa-celsian crystal.

An amorphous glass according to an embodiment of the present invention including, in terms of molar percentage based on oxides:
40% to 70% of SiO₂;
7.5% to 30% of Al₂O₃;
0.5% to 15% of P₂O₅;
13% to 30% of a total content of one or more selected from SrO and BaO; and
2.5% to 10% of a total content of one or more selected from TiO₂ and ZrO₂.

### Advantageous Effects of Invention

According to the present invention, it is possible to provide a crystallized glass having excellent dielectric properties and thermal expansion coefficient as a glass substrate for use in a high frequency device, and an amorphous glass suitable for obtaining such a crystallized glass.

### DESCRIPTION OF EMBODIMENTS

In the present description, “to” indicating a numerical range is used in the sense of including the numerical values set forth before and after the “to” as a lower limit value and an upper limit value. Unless otherwise specified, “to” hereinafter in the present description is used in the same meaning.

In the present description, a glass composition is expressed in terms of molar percentage based on oxides otherwise specified, and mol % is simply expressed as “%”.

In the present description, the term “crystallized glass” refers to a glass in which a crystal is precipitated in a glass. In the present description, the term “crystallized glass” refers to a glass in which a diffraction peak indicating the crystal is recognized by an X-ray diffraction (XRD) method. In X-ray diffraction measurement, for example, a range of 20=10° to 90° is measured by using CuKα rays, and in the case where a diffraction peak appears, the precipitated crystal can be identified by, for example, a three strong ray method.

In the present description, the term “high frequency” refers to 10 GHz or more, preferably more than 30 GHz, and more preferably 35 GHz or more.

### <Crystallized Glass>

### (Crystal)

A crystallized glass according to the present embodiment (hereinafter referred to as the present crystallized glass) includes at least one crystal of a celsian crystal and a hexa-celsian crystal. The celsian crystal and the hexa-celsian crystal have the same composition but different crystal structures, and the composition thereof is represented by a chemical formula BaAl₂Si₂O₈ or SrAl₂Si₂O₈. In addition, the celsian crystal and the hexa-celsian crystal can also be precipitated as solid solutions of BaAl₂Si₂O₈ and SrAl₂Si₂O₈. Therefore, in the present description, a crystal composed of any of solid solutions of BaAl₂Si₂O₈, SrAl₂Si₂O₈, and BaAl₂Si₂O₈ and SrAl₂Si₂O₂ is referred to as the celsian crystal and the hexa-celsian crystal.

In the case of synthesis by a solid phase reaction method, the celsian crystal includes a monoclinic crystal structure, whereas the hexa-celsian crystal includes a hexagonal crystal structure. Hereinafter, in the present description, at least one crystal of the celsian crystal and the hexa-celsian crystal included in the crystallized glass may be collectively referred to as a “celsian/hexa-celsian crystal”. That is, the “celsian/hexa-celsian crystal” refers to either a celsian crystal or a hexa-celsian crystal in the case where the crystallized glass includes one of the crystals, and refers to both a celsian crystal and a hexa-celsian crystal in the case where the crystallized glass includes both the crystals.

A hole may be present in the celsian/hexa-celsian crystal included in the present crystallized glass. In the present description, a case where the crystal has the hole is also referred to as a celsian/hexa-celsian crystal.

A glass substrate for use in a high frequency device is required to reduce a transmission loss based on a dielectric loss, a conductor loss, and the like in order to ensure properties such as a quality and intensity of a high frequency signal. In a crystallized glass including a celsian/hexa-celsian crystal, a dielectric loss tangent and a relative dielectric constant tend to decrease as a proportion of the crystal in the crystallized glass increases.

In addition, the glass substrate for use in a high frequency device is also required to have a smaller difference in thermal expansion coefficient with other members (for example, a Si substrate or a Cu electrode) in the device. The crystallized glass including a celsian/hexa-celsian crystal may exhibit a thermal expansion coefficient suitable for the above application.

From the viewpoint of obtaining suitable dielectric properties and thermal expansion coefficient, a total content of the celsian/hexa-celsian crystal in the present crystallized glass is preferably 30 mass % or more, more preferably 45 mass % or more, still preferably 50 mass % or more, even more preferably 55 mass % or more, even still more preferably 60 mass % or more, particularly preferably 65 mass % or more, and most preferably 70 mass % or more, with respect to an amount of the entire crystallized glass.

In addition, from the viewpoint of obtaining suitable processing properties, the total content of the celsian/hexa-celsian crystal is preferably 90 mass % or less, more preferably 85 mass % or less, and still more preferably 80 mass % or less, with respect to the content of the entire crystallized glass. The total content of the celsian/hexa-celsian crystal may be 30 mass % to 90 mass % with respect to the content of the entire crystallized glass.

Here, the celsian/hexa-celsian crystal can be identified by X-ray diffraction measurement (XRD). Specifically, in the case where a peak having the largest intensity is confirmed in a range of 2θ=22.3 to 22.6 when the bulk body of the crystallized glass is crushed and is measured by XRD using CuKα rays at 2θ=10° to 90°, the crystallized glass includes a celsian crystal. In the case where the peak having the largest intensity is confirmed in a range of 2θ=25.6 to 25.8, the crystallized glass includes a hexa-celsian crystal.

In order to obtain a more accurate crystal structure, it is preferable to perform Rietveld analysis. According to the Rietveld analysis, quantitative analysis of the crystal phase and the amorphous phase and structural analysis of the crystal phase can be performed. The Rietveld method is described in “Crystal Analysis Handbook” edited by the Crystallographic Society of Japan Editing Committee of “Crystal Analysis Handbook” (Kyoritsu Shuppan, 1999, p 492 to 499). The content of the celsian/hexa-celsian crystal in the present crystallized glass can be calculated by Rietveld analysis using a measurement result obtained by the XRD.

As a factor in improving the dielectric properties of the present crystallized glass, a total content (atom %) of Si and Al in the celsian/hexa-celsian crystal in the present crystallized glass is preferably 4 times or more a total content (atom %) of Ba and Sr in the crystal. This is presumed to be because the relatively large amounts of Si and Al included in the crystal shorten a distance that atoms move when an electric field is applied, resulting in a decrease in dielectric constant.

The present crystallized glass may include a crystal other than the celsian/hexa-celsian crystal as long as the effects of the present invention are not impaired. Examples of the crystal other than the celsian/hexa-celsian crystal include mullite, corundum, rutile, and anatase. In the case where the crystal other than the celsian/hexa-celsian crystal is included, a total content thereof is preferably 10 mass % or less, more preferably 8 mass % or less, and still more preferably 6 mass % or less, with respect to the content of the entire crystallized glass. The identification of a crystal seed and the measurement of the content of the crystal other than the celsian/hexa-celsian crystal can be performed by the Rietveld analysis using the XRD measurement and the XRD measurement result described above.

### (Composition)

A composition of the present crystallized glass is the same as a composition of an amorphous glass before crystallization to be described later. Here, the composition of the crystallized glass in the present description refers to a total composition of the composition of the crystal phase and the glass phase in the crystallized glass. The composition of the crystallized glass is determined by subjecting the crystallized glass to a heat treatment at a temperature equal to or higher than a melting point and analyzing the vitrified product. An example of the analysis method is a fluorescent X-ray analysis method. The composition of the crystal phase in the present crystallized glass can be analyzed by the Rietveld analysis of the result obtained by the XRD measurement described above. In the composition of the present crystallized glass, a preferred lower limit of a content of a non-essential component is 0%.

The present crystallized glass includes, in terms of molar percentage based on oxides, 40% to 70% of SiO₂, 7.5% to 30% of Al₂O₃, 0.5% to 15% of P₂O₅, 13% to 30% of a total content of one or more selected from SrO and BaO, and 2.5% to 10% of a total content of one or more selected from TiO₂ and ZrO₂. SiO₂, Al₂O₃, and SrO or BaO are components constituting the celsian/hexa-celsian crystal.

SiO₂ is a component for precipitating the celsian/hexa-celsian crystal as a crystal phase. The content of SiO₂ is preferably 40% or more. When the content of SiO₂ is 40% or more, the precipitated crystal phase of the crystallized glass is easily stabilized. The content of SiO₂ is more preferably 42% or more, still more preferably 44% or more, even more preferably 45% or more, particularly preferably 46% or more, even still more preferably 48% or more, and most preferably 50% or more. In addition, the content of SiO₂ is preferably 70% or less. When the content of SiO₂ is 70% or less, it is easy to melt or mold a glass raw material. In addition, heat treatment conditions are also an important factor in order to precipitate the celsian/hexa-celsian crystal as the crystal phase, and a wider range of the heat treatment conditions can be selected by setting the content of SiO₂ to be equal to or less than the above upper limit value. The content of SiO₂ is more preferably 65% or less, still more preferably 60% or less, even more preferably 57.5% or less, particularly preferably 55% or less, and even still more preferably 52.5% or less.

Al₂O₃ is a component for precipitating the celsian/hexa-celsian crystal as the crystal phase. The content of Al₂O₃ is preferably 7.5% or more. When the content of Al₂O₃ is 7.5% or more, a desired crystal phase is easily obtained, the precipitated crystal phase of the crystallized glass is easily stabilized, and a rise in liquidus temperature can be prevented. The content of Al₂O₃ is more preferably 10% or more, still more preferably 12.5% or more, even more preferably 15% or more, and particularly preferably 17.5% or more. On the other hand, the content of Al₂O₃ is preferably 30% or less. When the content of Al₂O₃ is 30% or less, meltability of the glass raw material is easily improved. The content of Al₂O₃ is more preferably 29% or less, still more preferably 28% or less, even more preferably 27.5% or less, particularly preferably 27% or less, even still more preferably 26% or less, yet still more preferably 23% or less, and most preferably 20% or less.

P₂O₅ is a component for improving the meltability of the glass raw material without deteriorating the dielectric properties of the crystallized glass. The content of P₂O₅ is preferably 0.5% or more. When the content of P₂O₅ is 0.5% or more, a desired crystal is easily obtained, the precipitated crystal phase of the crystallized glass is easily stabilized, and the meltability of the glass raw material is further improved. The content of P₂O₅ is more preferably 1.0% or more, still more preferably 1.5% or more, even more preferably 2.0% or more, and particularly preferably 2.5% or more. On the other hand, the content of P₂O₅ is preferably 15% or less. When the content of P₂O₅ is 15% or less, a desired crystal is easily obtained. The content of P₂O₅ is more preferably 10% or less, still more preferably 8.0% or less, even more preferably 6.0% or less, particularly preferably 5.0% or less, and even particularly preferably 4.0% or less.

The mechanism by which P₂O₅ contributes to improving the meltability of the glass raw material in the present crystallized glass without deteriorating the dielectric properties is presumed as follows.

As described above, the present crystallized glass preferably includes more Si and Al than Ba and Sr in the celsian/hexa-celsian crystal, and particularly, the total content (atom %) of Si and Al in the crystal is preferably 4 times or more the total content (atom %) of Ba and Sr in the crystal. Since P has a structure very similar to Si and Al in the glass, it is thought that Si and Al move easily when the amorphous glass before crystallization is subjected to a heat treatment. Therefore, it is presumed that Si and Al are easily included in the crystal, and as a result, the dielectric properties of the crystallized glass are improved.

BaO and SrO are components for precipitating the celsian/hexa-celsian crystal as the crystal phase. In order to obtain a desired crystal phase, it is sufficient to include at least one of BaO and SrO. The total content of BaO and SrO is preferably 13% or more. When the total content of BaO and SrO is 13% or more, a desired crystal is easily obtained and the precipitated crystal phase of the crystallized glass is easily stabilized. The total content of BaO and SrO is more preferably 15% or more, still more preferably 17% or more, even more preferably 18% or more, particularly preferably 19% or more, and even still more preferably 20% or more. On the other hand, the total content of BaO and SrO is preferably 30% or less. When the total content of BaO and SrO is 30% or less, a desired crystal can be easily obtained. The total content of BaO and SrO is more preferably 28% or less, still more preferably 26% or less, even more preferably 25% or less, particularly preferably 24% or less, and even still more preferably 23% or less.

The present crystallized glass preferably includes a nucleation component. The nucleation component is a component capable of generating a nucleus serving as a starting point of crystal growth when an amorphous glass is crystallized. By including the nucleation component, it is easier to stably obtain a desired crystal structure and a state where the crystal is relatively homogeneously dispersed in the crystallized glass. Examples of the nucleation component include TiO₂ and ZrO₂. As the nucleation component, TiO₂ is preferred from the viewpoint of stably precipitating the celsian/hexa-celsian crystal.

A total content of the nucleation component is preferably 2.5% or more, more preferably 3.0% or more, still more preferably 4.0% or more, and even more preferably 4.5% or more, from the viewpoint of allowing the nucleation component as a nucleating agent present to exist in the entire glass a certain concentration or more. In addition, the total content of the nucleation component is preferably 10% or less, more preferably 9% or less, still more preferably 8% or less, and even more preferably 7% or less, from the viewpoint of increasing a proportion of the celsian/hexa-celsian crystal in the entire crystallized glass and improving the dielectric properties.

For example, a total content of TiO₂ and ZrO₂ is preferably 2.5% or more, more preferably 3.0% or more, still more preferably 4.0% or more, and even more preferably 4.5% or more, from the viewpoint of allowing the same as a nucleating agent to exist in the entire glass at a certain concentration or more. In addition, the total content of TiO₂ and ZrO₂ is preferably 10% or less, more preferably 9% or less, still more preferably 8% or less, and even more preferably 7% or less, from the viewpoint of increasing the proportion of the celsian/hexa-celsian crystal in the entire crystallized glass and improving the dielectric properties.

TiO₂ is a component that functions as the nucleation component described above, and that contributes to refining the precipitated crystal phase, improvement in mechanical strength of a material, and improvement in chemical durability. In the case where TiO₂ is included, the content thereof is preferably 2.5% or more, more preferably 3.0% or more, still more preferably 4.0% or more, and even more preferably 4.5% or more, from the viewpoint of stably precipitating the celsian/hexa-celsian crystal. In addition, the content of TiO₂ is preferably 10% or less, more preferably 9% or less, still more preferably 8% or less, and even more preferably 7% or less, from the viewpoint of preventing the precipitation of crystals such as rutile that may deteriorate the dielectric properties of the crystallized glass.

ZrO₂ is a component that functions as the nucleation component described above, and that contributes to refining the precipitated crystal phase, the improvement in mechanical strength of the material, and the improvement in chemical durability. In the case where ZrO₂ is included, the content thereof is preferably 2.5% or more, more preferably 3.0% or more, still more preferably 4.0% or more, and even more preferably 4.5% or more, from the viewpoint of stably precipitating the celsian/hexa-celsian crystal. In addition, the content of ZrO₂ is preferably 10% or less, more preferably 9% or less, still more preferably 8% or less, and even more preferably 7% or less, from the viewpoint of increasing the proportion of the celsian/hexa-celsian crystal in the entire crystallized glass and improving the dielectric properties.

B₂O₃ is not an essential component, but may be included because it is a component that contributes to adjusting a viscosity and improving the dielectric properties during melt molding of the glass raw material. In the case where B₂O₃ is included, the content thereof is preferably 20% or less, more preferably 15% or less, still more preferably 10% or less, even more preferably 7.5% or less, particularly preferably 5% or less, and even still more preferably 2.5% or less.

Li₂O, Na₂O, K₂O, Rb₂O, and Cs₂O may or may not be included, but may be included in order to improve the meltability of the glass raw material. In the case where Li₂O, Na₂O, K₂O, Rb₂O, and Cs₂O are included, a total content thereof is preferably 2% or less, more preferably 1.5% or less, still more preferably 1% or less, and even more preferably 0.5% or less.

MgO and CaO may or may not be included, but may be included in order to improve the meltability of the glass raw material. In the case where MgO and CaO are included, a total content thereof is preferably 3% or less, more preferably 2.5% or less, still more preferably 2% or less, even more preferably 1.5% or less, and particularly preferably 1% or less.

ZnO may or may not be included, but may be included in order to improve the meltability of the glass raw material. In the case where ZnO is included, the content thereof is preferably 3% or less, more preferably 2.5% or less, still more preferably 2% or less, even more preferably 1.5% or less, and particularly preferably 1% or less.

Sb₂O₃ and As₂O₃ may or may not be included, but may be included in a total of 1% or less because of acting as a refining agent when melting the glass raw material.

F may or may not be included, but may be included in an amount of 3% or less in order to improve the meltability of the glass raw material. Note that, in the present description, the content (%) of F represents the content of the F element expressed in molar percentage.

SnO₂, CeO, and Fe₂O₃ may or may not be included, but may be included in a total of 5% or less of the components in order to improve detection sensitivity of surface defects due to coloring or a colorant of the glass and to improve absorption properties of LD-excited solid-state laser.

### (Physical Properties)

The present crystallized glass has a dielectric loss tangent Df at 20° C. and 10 GHz of preferably 0.003 or less, more preferably 0.0025 or less, still more preferably 0.0020 or less, even more preferably 0.0015 or less, particularly preferably 0.0010 or less, and even still more preferably 0.0005 or less, from the viewpoint of improving the dielectric properties. The dielectric loss tangent at 20° C. and 10 GHz is preferably as small as possible, and is usually 0.0001 or more.

The present crystallized glass has a relative dielectric constant Dk at 20° C. and 10 GHz of preferably 8.5 or less, more preferably 8.0 or less, still more preferably 7.5 or less, even more preferably 7.0 or less, and particularly preferably 6.8 or less, from the viewpoint of improving the dielectric properties. The relative dielectric constant at 20° C. and 10 GHz is preferably as small as possible, and is usually 3.5 or more.

The present crystallized glass has a total value of the dielectric loss tangent Df multiplied by 1000 and the relative dielectric constant Dk at 20° C. and 10 GHz of preferably 10.4 or less, more preferably 9.5 or less, still more preferably 9.0 or less, even more preferably 8.5 or less, particularly preferably 8.0 or less, and even still more preferably 7.5 or less, from the viewpoint of preventing a transmission delay. The total value of the dielectric constant and the dielectric loss tangent multiplied by 1000 at 20° C. and 10 GHz of the present crystallized glass is preferably as small as possible, and is usually 4.0 or more.

In the present crystallized glass, when at least the dielectric loss tangent Df at 20° C. and 10 GHz is within the above preferred range, it is thought that the dielectric properties in a band of a frequency higher than 10 GHz are also excellent. It is more preferable that in addition to the dielectric loss tangent, the relative dielectric constant Dk at 20° C. and 10 GHz and the total value of the dielectric loss tangent Df multiplied by 1000 and the relative dielectric constant Dk are within the above preferred ranges. The dielectric loss tangent and the relative dielectric constant can be measured using a cavity resonator and a vector network analyzer in accordance with a method defined in JIS R1641 (2007).

The present crystallized glass has an average thermal expansion coefficient at 50° C. to 350° C. of preferably 3.0 ppm/° C. or more, more preferably 3.5 ppm/° C. or more, still more preferably 4.0 ppm/° C. or more, particularly preferably 4.5 ppm/° C. or more, even still more preferably 5.0 ppm/° C. or more, and most preferably 5.5 ppm/° C. or more, from the viewpoint of reducing the difference in thermal expansion coefficient when the present crystallized glass is used, for example, by adhering to other members such as a Si substrate and a Cu electrode. In addition, the average thermal expansion coefficient at 50° C. to 350° C. is preferably 10 ppm/° C. or less, more preferably 9.5 ppm/° C. or less, still more preferably 9.0 ppm/° C. or less, even more preferably 8.5 ppm/° C. or less, particularly preferably 8.0 ppm/° C. or less, and even still more preferably 7.5 ppm/° C. or less, similarly from the viewpoint of reducing the difference in thermal expansion coefficient with other members. The average thermal expansion coefficient at 50° C. to 350° C. can be measured using a differential thermal expansion meter in accordance with a method defined in JIS R3102 (1995). The average thermal expansion coefficient at 50° C. to 350° C. of the present crystallized glass is preferably 3.0 ppm/° C. to 10 ppm/° C.

When the present crystallized glass satisfies the above composition range and includes at least one crystal of the celsian crystal and the hexa-celsian crystal, it is possible to obtain suitable dielectric properties and thermal expansion coefficient as a glass substrate for use in a high frequency device.

The present crystallized glass has a thermal conductivity at 20° C. of preferably 1.0 W/m-K or more, more preferably 1.2 W/m-K or more, still more preferably 1.5 W/m-K or more, even more preferably 1.6 W/m K or more, particularly preferably 1.7 W/m K or more, even particularly preferably 1.8 W/m-K or more, even still more preferably 1.9 W/m-K or more, and yet still more preferably 2.0 W/m K or more, from the viewpoint of highly efficient heat dissipation of the heat generated when the present crystallized glass is used as a glass substrate for a high frequency device. The thermal conductivity can be measured using a laser flash method thermophysical property measurement device in accordance with a method defined in JIS R1611 (2010). A higher thermal conductivity is more preferred, and it is usually 10 W/m K or less. The thermal conductivity can be adjusted according to a crystal content, a crystal seed, a crystal precipitation form, or the like. It is known that the thermal conductivity has a particularly high correlation with a crystallinity, and the thermal conductivity is generally 1.0 W/m K or less in a glass that is not crystallized, whereas the thermal conductivity is improved in a sample after the crystallization.

### (Shape)

A shape of the present crystallized glass is not particularly limited, and various shapes can be made according to the purpose and the application. For example, the present crystallized glass may have a plate shape including two main surfaces facing each other, or may have a shape other than the plate shape according to a product to be applied, the application, or the like. More specifically, the present crystallized glass may be, for example, a flat plate-shaped glass plate having no warpage or a curved glass plate having a curved surface. A shape of the main surface is not particularly limited, and can be molded into various shapes such as a circular shape and a quadrangular shape.

Preferred examples of the shape of the present crystallized glass include a shape including two main surfaces facing each other, and having an area of the main surface of 100 cm² to 100,000 cm² and a thickness of 0.01 mm to 2 mm.

The area of the main surface of the present crystallized glass is preferably 100 cm² or more, more preferably 225 cm² or more, and still preferably 400 cm² or more, from the viewpoint of transmission and reception efficiency in the case of using the present crystallized glass in an antenna or the like. In addition, the area of the main surface is preferably 100,000 cm² or less, more preferably 10,000 cm² or less, and still more preferably 3,600 cm² or less, from the viewpoint of handleability.

The thickness of the present crystallized glass is preferably 0.01 mm or more, more preferably 0.05 mm or more, and still more preferably 0.1 mm or more, from the viewpoint of maintaining the strength. The thickness of the present crystallized glass is preferably 2 mm or less, more preferably 1 mm or less, and still more preferably 0.7 mm or less, from the viewpoint of improving production efficiency and from the viewpoint of thinning and miniaturizing parts and products including the present crystallized glass.

### (Application)

The present crystallized glass is suitable for circuit boards of a high frequency device (electronic device) such as a semiconductor device for use in a communication device such as a mobile phone, a smartphone, a mobile information terminal, or a Wi-Fi device, a surface acoustic wave (SAW) device, and a radar component such as a radar transceiver, and substrates of an antenna component such as a liquid crystal antenna. The present crystallized glass has excellent dielectric properties, particularly in a high frequency range, and has a thermal expansion coefficient suitable in electronic device applications, and is thus suitable for a glass substrate for a high frequency device and a liquid crystal antenna.

### <Glass Substrate for High Frequency Device>

The present crystallized glass has excellent dielectric properties in a high frequency and also has an excellent thermal expansion coefficient, and can thus be used for a glass substrate for a high frequency device. A glass substrate for a high frequency device according to the present embodiment (hereinafter, also referred to as the present glass substrate for a high frequency device) including the present crystallized glass has preferred ranges of the relative dielectric constant, the dielectric loss tangent, the total value of the dielectric loss tangent multiplied by 1000 and the relative dielectric constant, the average thermal expansion coefficient, and the thermal conductivity same as those of the present crystallized glass.

The glass substrate for a high frequency device generally includes two main surfaces facing each other. The present glass substrate for a high frequency device has an area of the main surface of preferably 75 cm² or more, more preferably 100 cm² or more, still more preferably 150 cm² or more, even more preferably 300 cm² or more, and particularly preferably 600 cm² or more, from the viewpoint of the transmission and reception efficiency. The area of the main surface of the present high frequency substrate is preferably 5,000 cm² or less, from the viewpoint of ensuring the strength. The shape can be freely designed according to the application as long as the substrate has the above area. The area of the main surface of the present glass substrate for a high frequency device may be 75 cm² to 5,000 cm².

The present glass substrate for a high frequency device has a thickness of preferably 1 mm or less, more preferably 0.8 mm or less, and still more preferably 0.7 mm or less. The thickness is preferably within the above range since the overall thickness can be reduced when a circuit is formed by laminating the substrates. On the other hand, when the thickness is preferably 0.05 mm or more, and more preferably 0.2 mm or more, the strength can be ensured. The thickness of the present glass substrate for a high frequency device may be 0.05 mm to 1 mm.

In the case where the present crystallized glass is used as a substrate material for a high frequency device, a hole may be formed in a crystallized glass substrate including the present crystallized glass. That is, the present high frequency substrate may include a hole having an opening in at least one of the main surface. The hole may be a through hole communicating with the other main surface, or may be a non-penetrating void. When these holes are filled with a conductor or a conductor film is formed on a hole wall, the present glass substrate for a high frequency device may be used as a circuit.

The hole has a diameter of, for example, 200 μm or less, preferably 100 μm or less, and more preferably 50 m or less. On the other hand, the diameter of the hole is preferably 1 μm or more. The diameter of the hole may be 1 m to 200 μm.

A method of forming the hole is not particularly limited, and, for example, preferred is a method of irradiating the crystallized glass substrate with laser in order to form small hole having a diameter of 200 m or less with high accuracy. The substrate including the present crystallized glass has excellent processability by laser irradiation. A wavelength of the laser is not particularly limited, and, for example, a wavelength of 10.6 m or less, 3,000 nm or less, 2,050 nm or less, 1,090 nm or less, 540 nm or less, or 400 nm or less is used. In particular, in the case where small hole having a diameter of 100 μm or less is to be formed, the following two methods are preferred.

### (Processing by UV Laser)

A hole is formed in the crystallized glass substrate by emitting UV laser having a wavelength of 400 nm or less. The UV laser is more preferably pulse-oscillation, and during laser irradiation, an absorption layer is preferably disposed on the surface of the crystallized glass substrate. After the laser irradiation, the hole may be expanded by etching the crystallized glass substrate with a hydrofluoric acid-containing solution.

### (Processing by Forming Modified Portion)

Laser having a wavelength of 400 nm to 540 nm, for example, a wavelength of about 532 nm, is emitted to form a modified portion on the crystallized glass substrate. Subsequently, the crystallized glass substrate is etched with a hydrofluoric acid-containing solution to selectively remove the modified portion to thereby form the hole. According to such a method, since the laser or the like is pulse-oscillation and the modified portion can be formed only by one shot of pulse irradiation, a hole formation rate is high and productivity is excellent.

### <Liquid Crystal Antenna>

A liquid crystal antenna is a satellite communication antenna capable of controlling a direction of radio waves to be transmitted and received using a liquid crystal technique, and is suitably used mainly for a vehicle such as a ship, an airplane, and an automobile. Since the liquid crystal antenna is mainly expected to be used outdoors, stable properties in a wide temperature range are required. In addition, resistance to thermal shock due to a sudden temperature change, such as between on the ground and in the sky, and due to squalls on scorching deserts, is also required.

The present crystallized glass has excellent dielectric properties in a high frequency and thermal expansion coefficient and also has excellent thermal shock resistance, and can thus be used for the liquid crystal antenna. The liquid crystal antenna according to the present embodiment (hereinafter, also referred to as the present liquid crystal antenna) including the present crystallized glass has preferred ranges of the relative dielectric constant, the dielectric loss tangent, the total value of the dielectric constant and the dielectric loss tangent each multiplied by 1000, the average thermal expansion coefficient, and the thermal conductivity same as those of the present crystallized glass.

The liquid crystal antenna generally includes two main surfaces facing each other. The present liquid crystal antenna has an area of the main surface of preferably 75 cm² or more, more preferably 100 cm² or more, still more preferably 150 cm² or more, even more preferably 300 cm² or more, and particularly preferably 700 cm² or more, from the viewpoint of the transmission and reception efficiency. The area of the main surface of the present liquid crystal antenna is preferably 10,000 cm² or less, more preferably 3,600 cm² or less, and still more preferably 2,500 cm² or less, from the viewpoint of handleability. The shape can be freely designed according to the application as long as the substrate has the above area. The area of the main surface of the present liquid crystal antenna may be 75 cm² to 10,000 cm².

The present liquid crystal antenna has a thickness of preferably 1 mm or less, more preferably 0.8 mm or less, and still more preferably 0.7 mm or less. The thickness is preferably within the above range since the overall thickness can be reduced. On the other hand, when the thickness is preferably 0.05 mm or more, and more preferably 0.2 mm or more, the strength can be ensured. The thickness of the present liquid crystal antenna may be 0.05 mm to 1 mm.

### <Crystallized Glass Production Method>

Next, the present crystallized glass production method (hereinafter, also referred to as the present production method) will be described. Hereinafter, steps in a plate-shaped glass production method will be described, and the shape of the glass can be appropriately adjusted according to the purpose.

### (Amorphous Glass Molding Step)

In the present step, a raw material blended to have a desired glass composition is melted and molded to give an amorphous glass. The melting and molding method is not particularly limited, and the glass raw material prepared by blending the glass raw material is charged into a platinum crucible, followed by charging into an electric furnace at 1,300° C. to 1,700° C., melted, defoamed, and homogenized. The obtained molten glass is poured into a metal mold (for example, a stainless steel surface plate) at room temperature, held at a temperature of a glass transition point for about 3 hours, and then cooled to room temperature to obtain a glass block of the amorphous glass. In addition, the obtained glass block is subjected to processing such as cutting, grinding, or polishing as necessary and is molded into a desired shape. Note that, the processing such as cutting, grinding, or polishing may be performed after a crystallization step. In the case where the amorphous glass is processed before the crystallization step, the shape thereof is not particularly limited, and a preferred shape is the same as the preferred shape of the present crystallized glass.

In this way, the amorphous glass can be molded into a desired shape from a molten state, and thus has advantages that it is easy to mold or easily be made into a large area, and can be produced at a low cost in view of the crystallization step to be described later, as compared with a process of molding and firing a powder or slurry, such as ceramics, or a process of producing an ingot such as synthetic quartz and then cutting the ingot into a desired shape.

The amorphous glass includes, in terms of molar percentage based oxides, 40% to 70% of SiO₂, 7.5% to 30% of Al₂O₃, 0.5% to 15% of P₂O₅, 13% to 30% of a total content of one or more selected from SrO and BaO, and 2.5% to 10% of a total content of one or more selected from TiO₂ and ZrO₂, from the viewpoint of precipitating at least one crystal of the celsian crystal and the hexa-celsian crystal in the crystallized glass. Note that, a composition of the amorphous glass is the same as the composition of the present crystallized glass described above in <Crystallized Glass>, and details thereof are the same as those described above.

### (Crystallization Step)

Next, the amorphous glass obtained in the amorphous glass molding step is subjected to a heat treatment.

In the heat treatment, it is preferable to hold the amorphous glass at a specific treatment temperature for a specific holding time, and the treatment temperature and the holding time are not particularly limited as long as it is a condition under which at least one crystal of the celsian crystal and the hexa-celsian crystal can be precipitated.

Hereinafter, specific preferred conditions of the heat treatment will be described.

The treatment temperature is, for example, preferably 800° C. or higher, more preferably 850° C. or higher, and still more preferably 900° C. or higher, from the viewpoint of promoting precipitation of the celsian/hexa-celsian crystal, and from the viewpoint of shortening the heat treatment time and improving the productivity. On the other hand, the treatment temperature is preferably 1,400° C. or lower, more preferably 1,350° C. or lower, and still more preferably 1,300° C. or lower, from the viewpoint of preventing precipitation of a crystal other than the celsian/hexa-celsian crystal and from the viewpoint of the productivity.

The holding time is preferably 0.5 hours or longer, more preferably 1 hour or longer, still more preferably 2 hours or longer, and particularly preferably 3 hours or longer. When the holding time is within the above range, the crystallization sufficiently proceeds. On the other hand, since the heat treatment for a long time increases the cost required for the heat treatment, the holding time is preferably 24 hours or shorter, more preferably 12 hours or shorter, and particularly preferably 8 hours or shorter.

The heat treatment preferably includes holding at the above treatment temperature, and may further include increasing and decreasing the temperature within the range of the above treatment temperature or within another temperature range.

Specifically, for example, the temperature may be increased from room temperature to a first temperature range, held for a certain period of time, and then annealed to room temperature, and a two-stage heat treatment may be selected in which the temperature is increased from room temperature to a first temperature range and held for a certain period of time, then held for a certain period of time in a second temperature range that is higher than the first temperature range, and then annealed to room temperature.

In the case of the two-stage heat treatment, the first temperature range is preferably a temperature range in which a crystal nucleation rate increases in the glass composition. Specifically, the first temperature range is preferably 760° C. or higher, more preferably 800° C. or higher, and still more preferably 850° C. or higher. In addition, the first temperature range is preferably 960° C. or lower, more preferably 920° C. or lower, and still more preferably 880° C. or lower.

The holding time in the first temperature range is preferably 0.5 hours or longer, more preferably 1 hour or longer, still more preferably 1.5 hours or longer, and particularly preferably 2 hours or longer. When the holding time is within the above range, the nucleation is likely to proceed sufficiently. On the other hand, the holding time is preferably 5 hours or shorter, more preferably 4 hours or shorter, and particularly preferably 3 hours or shorter, from the viewpoint of preventing the progress of crystal growth simultaneously with the nucleation, and from the viewpoint of improving the dielectric properties of the entire crystallized glass.

The second temperature range is preferably a temperature range in which a crystal growth rate of the celsian/hexa-celsian crystal increases. Specifically, the second temperature range is preferably 960° C. or higher, more preferably 980° C. or higher, and still more preferably 1,000° C. or higher. In addition, the second temperature range is preferably 1,350° C. or lower, more preferably 1,250° C. or lower, and still more preferably 1,150° C. or lower.

The holding time in the second temperature range is preferably 1 hour or longer, more preferably 3 hours or longer, still more preferably 5 hours or longer, and particularly preferably 6 hours or longer. When the holding time is within the above range, the crystal growth is likely to proceed sufficiently. On the other hand, the holding time is preferably 24 hours or shorter, more preferably 18 hours or shorter, and particularly preferably 12 hours or shorter, from the viewpoint of the productivity.

A temperature increase rate in the heat treatment is not particularly limited, and is generally 1° C./min or more, preferably 3° C./min or more, and more preferably 5° C./min or more, from the viewpoint of the productivity.

On the other hand, when the temperature increase rate is preferably 30° C./min or less, and more preferably 25° C./min or less, a glass having a stable shape can be produced.

A temperature decrease rate is not particularly limited, and when it is preferably 10° C./min or less, more preferably 5° C./min or less, and still more preferably 1° C./min or less, the glass is less likely to break during cooling and easily maintains the shape. On the other hand, the temperature decrease rate is generally 0.5° C./min or more.

### EXAMPLES

Hereinafter, the present invention will be described in detail with reference to Examples, but the present invention is not limited thereto. Tables 1 to 4 show the glass composition of each of samples prepared in terms of molar percentage and mass percentage based on oxides. Glasses 1 to 14 correspond to amorphous glasses according to Working Examples in the present embodiment, and glasses 15 to 19 correspond to Comparative Examples.

The amorphous glasses having the compositions of Glasses 1 to 14 and 19 were further subjected to a heat treatment to give crystallized glasses. The composition, heat treatment conditions, and properties of the prepared crystallized glasses are shown in Tables 5 and 6. The composition of the crystallized glass is the same as the composition of the amorphous glass before crystallization, and is shown in Tables 5 to 6 using the glass numbers in Tables 1 to 4.

The method of preparing the crystallized glasses serving as Working Examples and Comparative Examples will be specifically shown below. Glass raw materials were blended to have the compositions shown in Tables 1 to 4, and weighed to give 400 g of glass. Next, the mixed raw materials were charged into a platinum crucible, followed by charging into an electric furnace at 1,500° C. to 1,700° C., melted for about 3 hours, defoamed, and homogenized.

The obtained molten glass was poured into a metal mold, held at a temperature about 10° C. higher than the glass transition point for 1 hour, and then cooled to room temperature at a rate of 0.5° C./min, to obtain a glass block. The obtained glass block was cut, ground, and finally mirror-polished on both surfaces to obtain a glass plate having a thickness of 2 mm.

The obtained glass was subjected to a heat treatment. Specifically, the amorphous glass was heated to a temperature T1 at a predetermined temperature increase rate, held for a holding time t1, and then decreased in temperature. Note that, for Examples 1, 13, 15, and 16, a two-stage heat treatment was performed. Specifically, the amorphous glass was heated to the temperature T1 at a first temperature increase rate, held for the holding time t1, then heated to a temperature T2 at a second temperature increase rate, held for a holding time t2, and then decreased in temperature.

Conditions such as a specific temperature in the heat treatment were set to conditions shown in Tables 5 and 6, and the heat treatment was performed to obtain the crystallized glass. In addition, the properties described in Tables 5 and 6 were obtained from the obtained crystallized glass. Note that, in Tables 5 and 6, blanks “-” in the “crystallization condition” column indicate that the heat treatment under the corresponding condition is not performed, and blanks “-” in the “properties” column indicate that the corresponding physical property is not measured, or no crystals are included regarding the content of the crystal.

Methods for measuring the properties are shown below.

### (PXRD Measurement and Rietveld Analysis)

The obtained crystallized glass was subjected to PXRD measurement by the following procedure to identify a crystal seed.

### (PXRD Measurement Sample Preparation Conditions)

A crystallized glass plate subjected to a SPDR method was crushed using an agate mortar and an agate pestle, to obtain a powder for PXRD measurement.

### (PXRD Measurement Conditions)

Powder X-ray diffraction was measured under the following conditions to identify the precipitated crystal.

For identification of the crystal seed, a diffraction peak pattern recorded in an ICSD inorganic crystal structure database and an ICDD powder diffraction database was used.
Measurement device: SmartLab manufactured by Rigaku Corporation
Measurement method: concentration method
Tube voltage: 45 kV
Tube current: 200 mA
X-ray used: CuKα ray
Measurement range: 2θ=100 to 800
Speed: 10°/min
Step: 0.02°

### (Rietveld Measurement Sample Preparation Conditions)

A crystallized glass powder used in the PXRD measurement was passed through a mesh having an opening of 500 m, and then ZnO was added as a standard substance so as to be 10 wt % of the entire sample.

### (Rietveld Analysis Conditions)

The powder X-ray diffraction was measured under the following conditions, and the Rietveld analysis was performed using the obtained results.
Measurement device: SmartLab manufactured by Rigaku Corporation
Measurement method: concentration method
Tube voltage: 45 kV
Tube current: 200 mA
X-ray used: CuKα ray
Measurement range: 2θ=10° to 90°
Speed: 5°/min
Step: 0.01°

A powder X-ray diffraction profile obtained under the above conditions was analyzed using a Rietveld analysis program: Rietan FP. The analysis of each sample was converged such that Rwp representing a quality of analysis convergence was 10 or less. The Rietveld method is described in “Crystal Analysis Handbook” edited by the Crystallographic Society of Japan Editing Committee of “Crystal Analysis Handbook” (Kyoritsu Shuppan, 1999, p 492 to 499).

### (Crystallinity Calculation)

Calculation was performed such that the added 10 wt % of ZnO was subtracted from a weight ratio of a crystal phase obtained by the Rietveld analysis and a residual glass phase obtained by subtracting the content of the crystal phase from the total content of the measurement sample, and the remaining phase was 100 wt % in total.

### (Average Thermal Expansion Coefficient)

Measurement was performed using a differential thermal expansion meter in accordance with a method defined in JIS R3102 (1995). A measurement temperature range was 50° C. to 350° C., and the unit was represented as ppm/° C. As a sample, a sample obtained by processing a crystallized glass plate after the heat treatment into a circular (cylindrical) shape having a diameter of 5 mm and a thickness of 20 mm was used.

### (Thermal Conductivity)

According to a method defined in JIS R1611 (2010), the thernal conductivity was measured using laser flash method thermophysical property measurement device (LFA-502 manufactured by KYOTO ELECTRONICS MANUFACTURING CO., LTD). The measurement temperature was 20° C. As a sample, a sample obtained by processing a crystallized glass plate after the heat treatment into a circular shape having a diameter of 5 mm and a thickness of 1 mm was used.

### (Relative Dielectric Constant Dk and Dielectric Loss Tangent Df)

The obtained amorphous glass and crystallized glass were processed into a rectangular parallelepiped having a length of 30.0 mm, a width of 30.0 mm, and a thickness of 0.5 mm, and surfaces of 30.0 mm×30.0 mm were mirror-polished. The relative dielectric constant Dk and the dielectric loss tangent Df at 10 GHz were measured using a network analyzer by a slip post dielectric resonance method (SPDR method).

TABLE 1

| | Glass 1 | | Glass 2 | | Glass 3 | | Glass 4 | | Glass 5 | |
|---|---|---|---|---|---|---|---|---|---|---|
| | mol % | wt % | mol % | wt % | mol % | wt % | mol % | wt % | mol % | wt % |
| SiO₂ | 52.0 | 35.2 | 45.8 | 28.9 | 46.1 | 32.7 | 45.8 | 32.2 | 45.8 | 30.5 |
| Al₂O₃ | 21.0 | 24.2 | 26.6 | 28.5 | 26.6 | 32.0 | 26.6 | 31.8 | 26.6 | 30.1 |
| B₂O₃ | 0.0 | 0.0 | 0.0 | 0.0 | 0.0 | 0.0 | 0.0 | 0.0 | 0.0 | 0.0 |
| P₂O₅ | 2.4 | 3.8 | 3.0 | 4.5 | 3.0 | 5.0 | 3.0 | 5.0 | 3.0 | 4.7 |
| SrO | 0.0 | 0.0 | 0.0 | 0.0 | 21.5 | 26.3 | 19.6 | 23.8 | 9.8 | 11.3 |
| BaO | 17.6 | 30.4 | 19.6 | 31.6 | 0.0 | 0.0 | 0.0 | 0.0 | 9.8 | 16.7 |
| ZrO₂ | 0.0 | 0.0 | 5.0 | 6.5 | 2.8 | 4.1 | 5.0 | 7.2 | 5.0 | 6.8 |
| TiO₂ | 7.0 | 6.3 | 0.0 | 0.0 | 0.0 | 0.0 | 0.0 | 0.0 | 0.0 | 0.0 |
| Na₂O | 0.0 | 0.0 | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 |

TABLE 2

| | Glass 6 | | Glass 7 | | Glass 8 | | Glass 9 | | Glass 10 | |
|---|---|---|---|---|---|---|---|---|---|---|
| | mol % | wt % | mol % | wt % | mol % | wt % | mol % | wt % | mol % | wt % |
| SiO₂ | 52.0 | 39.1 | 45.8 | 33.2 | 45.8 | 32.7 | 48.2 | 30.7 | 48.2 | 34.4 |
| Al₂O₃ | 21.0 | 26.8 | 26.6 | 32.7 | 26.6 | 32.3 | 25.0 | 27.0 | 25.0 | 30.3 |
| B₂O₃ | 0.0 | 0.0 | 0.0 | 0.0 | 0.0 | 0.0 | 0.0 | 0.0 | 0.0 | 0.0 |
| P₂O₅ | 2.4 | 4.3 | 2.4 | 4.1 | 2.4 | 4.1 | 3.2 | 4.8 | 3.2 | 5.4 |
| SrO | 17.5 | 22.7 | 19.5 | 24.4 | 19.5 | 24.0 | 0.0 | 0.0 | 20.5 | 25.3 |
| BaO | 0.1 | 0.2 | 0.1 | 0.2 | 0.1 | 0.2 | 20.6 | 33.5 | 0.1 | 0.2 |
| ZrO₂ | 0.0 | 0.0 | 0.0 | 0.0 | 2.8 | 4.1 | 3.0 | 3.9 | 3.0 | 4.4 |
| TiO₂ | 7.0 | 7.0 | 5.6 | 5.4 | 2.8 | 2.7 | 0.0 | 0.0 | 0.0 | 0.0 |
| Na₂O | 0.0 | 0.0 | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 |

TABLE 3

| | Glass 11 | | Glass 12 | | Glass 13 | | Glass 14 | | Glass 15 | |
|---|---|---|---|---|---|---|---|---|---|---|
| | mol % | wt % | mol % | wt % | mol % | wt % | mol % | wt % | mol % | wt % |
| SiO₂ | 46.4 | 32.7 | 43.8 | 27.0 | 63.0 | 44.3 | 59.5 | 41.5 | 45.8 | 29.1 |
| Al₂O₃ | 25.0 | 29.9 | 24.6 | 25.7 | 11.6 | 13.8 | 11.6 | 13.7 | 26.9 | 29.0 |
| B₂O₃ | 0.0 | 0.0 | 0.0 | 0.0 | 0.0 | 0.0 | 0.0 | 0.0 | 0.0 | 0.0 |
| P₂O₅ | 2.4 | 4.0 | 7.0 | 10.2 | 2.4 | 4.0 | 2.4 | 4.0 | 0.0 | 0.0 |
| SrO | 19.2 | 23.3 | 0.0 | 0.0 | 0.0 | 0.0 | 0.0 | 0.0 | 0.0 | 0.0 |
| BaO | 0.0 | 0.0 | 19.6 | 30.8 | 19.0 | 34.1 | 19.0 | 33.8 | 19.6 | 31.8 |
| ZrO₂ | 7.0 | 10.1 | 5.0 | 6.3 | 0.0 | 0.0 | 0.0 | 0.0 | 7.7 | 10.0 |
| TiO₂ | 0.0 | 0.0 | 0.0 | 0.0 | 4.0 | 3.7 | 7.5 | 7.0 | 0.0 | 0.0 |
| Na₂O | 0.0 | 0.0 | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 |

TABLE 4

| | Glass 16 | | Glass 17 | | Glass 18 | | Glass 19 | |
|---|---|---|---|---|---|---|---|---|
| | mol | wt | mol | wt | mol | wt | mol | wt |
| | % | % | % | % | % | % | % | % |
| SiO₂ | 46.5 | 33.5 | 50.5 | 33.2 | 54.0 | 36.9 | 45.8 | 29.7 |
| Al₂O₃ | 27.7 | 33.9 | 26.9 | 30.0 | 18.0 | 20.8 | 26.6 | 29.3 |
| B₂O₃ | 0.0 | 0.0 | 0.0 | 0.0 | 5.0 | 4.0 | 0.0 | 0.0 |
| P₂O₅ | 0.0 | 0.0 | 0.0 | 0.0 | 0.0 | 0.0 | 0.0 | 0.0 |
| SrO | 23.4 | 29.1 | 0.0 | 0.0 | 0.0 | 0.0 | 0.0 | 0.0 |
| BaO | 0.0 | 0.0 | 19.6 | 32.8 | 18.0 | 31.3 | 19.6 | 32.4 |
| ZrO₂ | 2.4 | 3.5 | 3.0 | 4.0 | 5.0 | 7.0 | 5.0 | 6.6 |
| TiO₂ | 0.0 | 0.0 | 0.0 | 0.0 | 0.0 | 0.0 | 0.0 | 0.0 |
| Na₂O | 0.0 | 0.0 | 0.0 | 0.0 | 0.0 | 0.0 | 3.0 | 2.0 |
| Total | 100.0 | 100.0 | 100.0 | 100.0 | 100.0 | 100.0 | 100.0 | 100.0 |

TABLE 5

| | Example | Example | Example | Example | Example | Example | Example | Example | Example |
|---|---|---|---|---|---|---|---|---|---|
| | 1 | 2 | 3 | 4 | 5 | 6 | 7 | 8 | 9 |
| Working Example or | Working | Working | Working | Working | Working | Working | Working | Working | Working |
| Comparative Example | Example | Example | Example | Example | Example | Example | Example | Example | Example |
| Glass number | 1 | 2 | 3 | 4 | 4 | 5 | 5 | 6 | 7 |
| (composition) | | | | | | | | | |
| Crystallization conditions | | | | | | | | | |
| Heating rate to T1 | 5 | 5 | 5 | 5 | 5 | 5 | 5 | 5 | 5 |
| [° C./min] | | | | | | | | | |
| Temperature T1 [° C.] | 860 | 1070 | 1300 | 1070 | 1400 | 1070 | 1400 | 1070 | 1070 |
| Holding time t1 [h] | 6 | 4 | 4 | 4 | 4 | 4 | 4 | 4 | 4 |
| Heating rate to T2 | 5 | — | — | — | — | — | — | — | — |
| [° C./min] | | | | | | | | | |
| Temperature T2 [° C.] | 1300 | — | — | — | — | — | — | — | — |
| Holding time t2 [h] | 4 | — | — | — | — | — | — | — | — |
| Properties | | | | | | | | | |
| Celsian [mass %] | 50% | — | 75% | 40% | 75% | — | 25% | — | 50% |
| hexa-Celsian [mass %] | — | 50% | — | — | — | 55% | 30% | 65% | 20% |
| Others [mass %] | 3% | — | — | — | — | — | — | 6% | — |
| Ba or Sr/Si | 42% | 47% | 47% | 47% | 46% | 47% | 45% | 29% | 33% |
| Ba or Sr/Al | 45% | 47% | 47% | 47% | 46% | 47% | 48% | 30% | 33% |
| (Si + Al)/(Ba + Sr) | 4.6 | 4.3 | 4.3 | 4.3 | 4.3 | 4.2 | 4.3 | 6.8 | 6.0 |
| Average thermal expansion | 3.6 | 7.6 | 7.7 | 8.1 | 7.9 | 6.3 | 5.5 | 3.8 | 5.9 |
| coefficient (50° C. to | | | | | | | | | |
| 350° C.) ppm/° C. | | | | | | | | | |
| Thermal conductivity λ | — | 2.3 | — | — | — | — | — | — | — |
| [W/m · K] | | | | | | | | | |
| Dk @ 10 GHz | 8.0 | 7.3 | 6.8 | 6.6 | 7.5 | 7.1 | 7.3 | 7.7 | 7.3 |
| Df @ 10 GHz | 0.0022 | 0.0022 | 0.0006 | 0.0010 | 0.0009 | 0.0022 | 0.0023 | 0.0005 | 0.0006 |
| Dk + Df × 1000 @ 10 GHz | 10.1900 | 9.5000 | 7.4400 | 7.6200 | 8.3500 | 9.2900 | 9.6200 | 8.2400 | 7.8600 |

TABLE 6

| | Example | Example | Example | Example | Example | Example | Example | Example |
|---|---|---|---|---|---|---|---|---|
| | 10 | 11 | 12 | 13 | 14 | 15 | 16 | 17 |
| Working Example or | Working | Working | Working | Working | Working | Working | Working | Comparative |
| Comparative Example | Example | Example | Example | Example | Example | Example | Example | Example |
| Glass number (composition) | 8 | 9 | 10 | 11 | 12 | 13 | 14 | 19 |
| Crystallization conditions | | | | | | | | |
| Heating rate to T1 [° C./min] | 5 | 5 | 5 | 5 | 5 | 5 | 5 | 5 |
| Temperature T1 [° C.] | 1070 | 1300 | 1300 | 860 | 1070 | 950 | 950 | 1070 |
| Holding time t1 [h] | 4 | 4 | 4 | 6 | 4 | 4 | 4 | 4 |
| Heating rate to T2 [° C./min] | — | — | — | 5 | — | 5 | 5 | — |
| Temperature T2 [° C.] | — | — | — | 1300 | — | 1100 | 1100 | — |
| Holding time t2 [h] | — | — | — | 4 | — | 24 | 24 | — |
| Properties | | | | | | | | |
| Celsian [mass %] | — | — | — | — | — | — | — | — |
| hexa-Celsian [mass %] | 45% | 30% | 80% | 50% | 50% | 50% | 50% | 50% |
| Others [mass %] | — | — | 5% | 2% | — | 7% | 7% | — |
| Ba or Sr/Si | — | 50% | 37% | 54% | 47% | — | — | — |
| Ba or Sr/Al | — | 50% | 39% | 54% | 47% | — | — | — |
| (Si + Al)/(Ba + Sr) | 4.2 | 4.0 | 5.2 | 3.7 | 4.3 | — | — | — |
| Average thermal expansion | 8.1 | 6.2 | 4.1 | 6.5 | 8.2 | — | — | 6.9 |
| coefficient (50° C. to 350° C.) | | | | | | | | |
| ppm/° C. | | | | | | | | |
| Thermal conductivity λ | — | — | — | — | 1.9 | — | — | — |
| [W/m · K] | | | | | | | | |
| Dk @ 10 GHz | 6.7 | 6.6 | 7.0 | 8.0 | 7.6 | 7.4 | 7.5 | 7.9 |
| Df @ 10 GHz | 0.0004 | 0.0012 | 0.0007 | 0.0023 | 0.0022 | 0.0007 | 0.0009 | 0.0089 |
| Dk + Df × 1000 @ 10 GHz | 7.0700 | 7.8300 | 7.7300 | 10.3300 | 9.8000 | 8.1000 | 8.4000 | 16.8000 |

The precipitated crystal proportions in Tables 5 and 6 are the precipitated proportions of crystals calculated using the Rietveld analysis, expressed in mass %. In addition, (Si+Al)/(Ba+Sr) is determined based on a ratio of a total atom % of Si and Al to a total atom % of Ba and Sr included in the celsian/hexa-celsian crystal calculated from the Rietveld analysis.

It can be seen that the crystallized glasses in Examples 1 to 16 that are Working Examples obtained using the glasses 1 to 14 have good values for the relative dielectric constant, the dielectric loss tangent, the total value of the dielectric loss tangent Df multiplied by 1000 and the relative dielectric constant Dk, and the average thermal expansion coefficient, and have physical properties suitable as a glass substrate for use in a high frequency device.

On the other hand, it can be seen that the glasses 15 to 18 do not include P₂O₅, and are thus difficult to melt even at a melting temperature of 1,700° C., resulting in low production efficiency.

It can be seen that, in order to improve the meltability of the raw materials, the crystallized glass in Example 17, which is Comparative Example, obtained using the glass 19 including Na₂O instead of P₂O₅, has improved meltability, but has a dielectric loss tangent Df of 0.0089 at 20° C. and 10 GHz, a total value of the dielectric loss tangent Df multiplied by 1000 and the relative dielectric constant Dk of 16.8, and deteriorated dielectric properties.

As described above, the following matters are disclosed in the present description.
1. A crystallized glass having a composition that includes, in terms of molar percentage based on oxides:
   40% to 70% of SiO₂;
   7.5% to 30% of Al₂O₃;
   0.5% to 15% of P₂O₅;
   13% to 30% of a total content of one or more selected from SrO and BaO; and
   2.5% to 10% of a total content of one or more selected from TiO₂ and ZrO₂, and comprising at least one crystal of a celsian crystal and a hexa-celsian crystal.
2. The crystallized glass according to the above 1, including 1.0% to 5.0% of P₂O₅ in terms of molar percentage based on oxides.
3. The crystallized glass according to the above 1 or 2, including 10% to 20% of Al₂O₃ in terms of molar percentage based on oxides.
4. The crystallized glass according to any one of the above 1 to 3, having a total content of the crystal of 30 mass % or more with respect to a content of the entire crystallized glass.
5. The crystallized glass according to any one of the above 1 to 4, in which a total content (atom %) of Si and Al in the crystal is 4 times or more a total content (atom %) of Ba and Sr in the crystal.
6. The crystallized glass according to any one of the above 1 to 5, having a dielectric loss tangent Df at 10 GHz and 20° C. of 0.003 or less.
7. The crystallized glass according to any one of the above 1 to 6, having a relative dielectric constant Dk at 10 GHz and 20° C. of 8.5 or less.
8. The crystallized glass according to any one of the above 1 to 7, having a total value of the dielectric loss tangent Df multiplied by 1000 and the relative dielectric constant Dk at 10 GHz and 20° C. of 10.4 or less.
9. The crystallized glass according to any one of the above 1 to 8, having an average thermal expansion coefficient at 50° C. to 350° C. of 3.0 ppm/° C. or more.
10. The crystallized glass according to any one of the above 1 to 9, having a thermal conductivity at 20° C. of 1.0 W/m-K or more.
11. The crystallized glass according to any one of the above 1 to 10, in which the crystallized glass includes two main surfaces facing each other, and an area of the main surface is 100 cm² to 100,000 cm².
12. The crystallized glass according to any one of the above 1 to 11, having a thickness of 0.01 mm to 2 mm.
13. A glass substrate for a high frequency device, including:
   the crystallized glass according to any one of the above 1 to 12.
14. A liquid crystal antenna including:
   the crystallized glass according to any one of the above 1 to 12.
15. An amorphous glass including, in terms of molar percentage based on oxides:
   40% to 70% of SiO₂;
   7.5% to 30% of Al₂O₃;
   0.5% to 15% of P₂O₅;
   13% to 30% of a total content of one or more selected from SrO and BaO; and
   2.5% to 10% of a total content of one or more selected from TiO₂ and ZrO₂.
16. A crystallized glass production method including:
   holding the amorphous glass according to the above 15 at 960° C. or higher for 3 hours or longer.

Although the present invention has been described in detail with reference to specific embodiments, it is apparent to those skilled in the art that various changes and modifications can be made without departing from the spirit and scope of the present invention. The present application is based on a Japanese Patent Application (No. 2022-004642) filed on Jan. 14, 2022, the contents of which are incorporated herein by reference.

### INDUSTRIAL APPLICABILITY

The crystallized glass according to the present invention has dielectric properties and thermal expansion coefficient suitable as a glass substrate for use in a high frequency device.

Such a crystallized glass is very useful as a member of general high frequency electronic devices such as a high frequency substrate that copes with a high frequency signal exceeding 10 GHz, particularly a high frequency signal exceeding 30 GHz, and further a high frequency signal of 35 GHz or more, of liquid crystal antennas for use in an environment where a temperature change is large, of devices involving drilling by laser, or the like.

1. A crystallized glass having a composition that comprises, in terms of molar percentage based on oxides:
40% to 70% of SiO₂;
7.5% to 30% of Al₂O₃;
0.5% to 15% of P₂O₅;
13% to 30% of a total content of one or more selected from SrO and BaO; and
2.5% to 10% of a total content of one or more selected from TiO₂ and ZrO₂, and comprising at least one crystal of a celsian crystal and a hexa-celsian crystal.

2. The crystallized glass according to claim 1, comprising 1.0% to 5.0% of P₂O₅ in terms of molar percentage based on oxides.

3. The crystallized glass according to claim 1, comprising 10% to 20% of Al₂O₃ in terms of molar percentage based on oxides.

4. The crystallized glass according to claim 1, having a total content of the crystal of 30 mass % or more with respect to a content of the entire crystallized glass.

5. The crystallized glass according to claim 1, wherein a total content (atom %) of Si and Al in the crystal is 4 times or more a total content (atom %) of Ba and Sr in the crystal.

6. The crystallized glass according to claim 1, having a dielectric loss tangent Df at 10 GHz and 20° C. of 0.003 or less.

7. The crystallized glass according to claim 1, having a relative dielectric constant Dk at 10 GHz and 20° C. of 8.5 or less.

8. The crystallized glass according to claim 1, having a total value of a dielectric loss tangent Df multiplied by 1000 and a relative dielectric constant Dk at 10 GHz and 20° C. of 10.4 or less.

9. The crystallized glass according to claim 1, having an average thermal expansion coefficient at 50° C. to 350° C. of 3.0 ppm/° C. or more.

10. The crystallized glass according to claim 1, having a thermal conductivity at 20° C. of 1.0 W/m K or more.

11. The crystallized glass according to claim 1, wherein the crystallized glass comprises two main surfaces facing each other, and an area of the main surface is 100 cm² to 100,000 cm².

12. The crystallized glass according to claim 1, having a thickness of 0.01 mm to 2 mm.

13. A glass substrate for a high frequency device, comprising:
the crystallized glass according to claim 1.

14. A liquid crystal antenna comprising:
the crystallized glass according to claim 1.

15. An amorphous glass comprising, in terms of molar percentage based on oxides:
40% to 70% of SiO₂;
7.5% to 30% of Al₂O₃;
0.5% to 15% of P₂O₅;
13% to 30% of a total content of one or more selected from SrO and BaO; and
2.5% to 10% of a total content of one or more selected from TiO₂ and ZrO₂.

16. A crystallized glass production method comprising:
holding the amorphous glass according to claim 15 at 960° C. or higher for 3 hours or longer.
